(19) United States
(12) Patent Application Publication
(10) Pub. No.: US 2016/0191118 A1
(43) Pub. Date: Jun. 30, 2016

(54) ENHANCING SINGLE-ENDED LOOP TESTING SIGNALS

(71) Applicant: Ikanos Communications, Inc., Fremont, CA (US)

(72) Inventor: Raghunath Kalavai, Bedminster, NJ (US)

(21) Appl. No.: 14/985,265

(22) Filed: Dec. 30, 2015

Related U.S. Application Data
(60) Provisional application No. 62/098,018, filed on Dec. 30, 2014.

(51) Int. Cl. H04B 3/46; H04M 3/22; H04M 3/30

(52) U.S. Cl. CPC H04B 3/46; H04M 3/301; H04M 3/304; H04M 3/2209

(57) ABSTRACT

Methods, systems, and devices are described for wired communication. In one aspect, a method relates to a scheme to filter and enhance a time domain reflectometry (TDR) plot with pre-processing such that the plot shows impairments clearly and reduces spurious peaks. The method includes receiving one or more reflected signals in response to a transmitted test signal. The method also includes determining a time domain reflectometry (TDR) signal based at least in part on frequency response data associated with the received one or more reflected signals. Additionally, the method includes applying a de-emphasis windowing function to the TDR signal.

### CROSS REFERENCES

The present Application for Patent claims priority to U.S. Provisional Patent Application No. 62/098,018 by Kalavai, entitled “Enhancement of SELT TDR Signal for Display on Technician Handheld Unit,” filed Dec. 30, 2014, assigned to the assignee hereof, and expressly incorporated by reference herein.

### BACKGROUND

1. Field of the Disclosure

The present disclosure relates generally to data communications, and more particularly to techniques for enhancing single-ended loop testing signals.

2. Description of Related Art

In wired communications such as digital subscriber line (DSL) systems, coaxial cable systems, etc., loop diagnostics are often based on the analysis of single-ended loop (or line) testing (SELT) processes. Typically, a SELT analysis tool will detect impairments such as bridge taps, line cuts, or bad splices. For example, in single-ended line tests (see, e.g., ITU-T G.996.2, SERIES G: TRANSMISSION SYSTEMS AND MEDIA, DIGITAL SYSTEMS AND NETWORKS, Digital sections and digital line system—Access networks, Line Testing for Digital Subscriber lines (DSL), May 2009), a known signal is sent over the loop and the reflected signal is analyzed to determine loop characteristics and any impairments present on the transmission line. However, problems remain in accurately identifying and locating impairments using SELT processes.

### SUMMARY

The present description discloses techniques for measuring impairments in a transmission line, such as a DSL line, using time domain reflectometry (TDR). According to these techniques, a test device coupled to one end of the transmission line transmits a test signal on the transmission line and receives one or more reflected signals over the transmission line. The test device can then determine a TDR signal using frequency response data associated with the received one or more reflected signals, and apply a de-emphasis windowing function to the TDR signal. The de-emphasis windowing function smoothes the TDR signal to de-emphasize portions of the signal that resemble but are not indicative of short circuits, open circuits, or other line impairments. The TDR signal displayed or conveyed by the test device can then more precisely indicate actual line impairments to a technician operating the diagnostic device.

A method for measuring impairments in a transmission line is described. The method includes receiving one or more reflected signals in response to a transmitted test signal; determining a time domain reflectometry (TDR) signal based at least in part on frequency response data associated with the received one or more reflected signals; and applying a de-emphasis windowing function to the TDR signal.

A device for measuring impairments in a transmission line is also described. The device includes a signal transmitter to transmit a test signal on the DSL transmission line; a signal capture manager to receive one or more reflected signals in response to the transmitted test signal and to convert the one or more reflected signals into frequency domain data; an inverse fast Fourier transform (IFFT) manager to perform an IFFT function on the frequency domain data to generate a time domain reflectometry (TDR) signal; and a de-emphasis windowing manager to apply a de-emphasis windowing function to the TDR signal.

Another device for measuring impairments in a transmission line is described. The device includes means for receiving one or more reflected signals in response to a transmitted test signal; means for determining a time domain reflectometry (TDR) signal based at least in part on frequency response data associated with the received one or more reflected signals; and means for applying a de-emphasis windowing function to the TDR signal.

A non-transitory computer-readable medium is also disclosed. The non-transitory computer-readable medium includes computer-readable code that, when executed, causes a device to: transmit a test signal on a digital subscriber line (DSL), the test signal being transmitted in at least one upstream frequency band and at least one downstream frequency band in a DSL system frequency band plan; receive one or more reflected signals in response to the transmitted test signal and convert the one or more reflected signals into frequency domain data; perform an inverse fast Fourier transform (IFFT) function on the frequency domain data to generate a time domain reflectometry (TDR) signal; apply a de-emphasis windowing function having a multi-slope linear window to the TDR signal; apply a moving average smoothing filter to the TDR signal; and determine a distance associated with each of one or more samples of the TDR signal after applying the de-emphasis windowing function and the moving average smoothing filter.

Regarding the above-described method, devices, and non-transitory computer-readable medium, a frequency domain windowing function can be applied to the frequency response data prior to determining the TDR signal. In some cases, determining the TDR signal includes performing an inverse fast Fourier transform (IFFT) function on the frequency response data. A moving average removal function can be applied to the TDR signal. Applying the de-emphasis windowing function can include applying a multi-slope linear window.

A moving average smoothing filter can be applied to the received one or more reflected signals, the TDR signal, and/or a frequency domain reflectometry (FDR) signal. Applying the moving average smoothing filter to the signal can include varying a number of samples associated with a window size of the moving average smoothing filter.

A distance associated with each of one or more samples of the TDR signal can be determined after applying the de-emphasis windowing function. The frequency response data can include frequency domain S11 data from at least one upstream frequency band and at least one downstream frequency band in a digital subscriber line (DSL) system frequency band plan. A de-emphasis attenuation factor of the de-emphasis windowing function can be based at least in part on a characteristic of the transmission line.

Further scope of the applicability of the described systems, methods, devices, or computer-readable media will become apparent from the following detailed description, claims, and drawings. The detailed description and specific examples are given by way of illustration only, and various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a DSL system in which techniques for enhancing SELT signals can be implemented in accordance with various aspects of the present disclosure;

FIG. 2 illustrates an example of a DSL system frequency band plan in which techniques for enhancing SELT signals can be implemented in accordance with various aspects of the present disclosure;

FIG. 3 shows a block diagram of an example of a test device that supports enhancing SELT signals in accordance with various aspects of the present disclosure;

FIGS. 4A and 4B show block diagrams of examples of test devices that support enhancing SELT signals in accordance with various aspects of the present disclosure;

FIG. 5 shows a flow chart that illustrates an example of a method for enhancing SELT signals in accordance with various aspects of the present disclosure;

FIG. 6 illustrates examples of TDR plots for a 300 ft. bridge tap at 700 ft. in accordance with various aspects of the present disclosure;

FIG. 7 illustrates examples of TDR plots for a line cut at 1500 ft. in accordance with various aspects of the present disclosure; and

FIG. 8 illustrates examples of TDR plots for a line cut at 4000 ft. in accordance with various aspects of the present disclosure.

### DETAILED DESCRIPTION

According to aspects of the present disclosure, a test device for measuring impairments on a DSL transmission line transmits a test signal on the DSL transmission line. The test signal can be transmitted in multiple upstream frequency bands and downstream frequency bands in a DSL system frequency band plan, and in some cases is transmitted across an entire bandwidth of the DSL system frequency band plan. The test device receives one or more reflected signals in response to the transmitted test signal and converts the one or more reflected signals into frequency domain data. The test device perform an inverse fast Fourier transform (IFFT) function on the frequency domain data to generate a TDR signal. In some cases, the frequency domain data includes frequency domain S11 data from both upstream and downstream frequency bands in the DSL system frequency band plan.

The test device applies a de-emphasis windowing function to the TDR signal. In some cases, the de-emphasis windowing function includes a multi-slope linear window. The test device also applies a moving average smoothing filter to the TDR signal. The test device then determine a distance associated with each of one or more samples of the TDR signal after applying the de-emphasis windowing function and the moving average smoothing filter. Accordingly, an enhanced TDR plot with distances can be presented for display on the test device (or a display unit operatively coupled to the test device). The enhanced TDR plot overcomes that the challenges with interpreting conventional TDR signals, which typically have significant noisy spikes that can confuse technical support personnel.

Removal of the noisy spikes without removing any legitimate transmission line impairment signatures is an advantage of the present disclosure. It is to be appreciated that a number of custom smoothing and windowing techniques (many of which are optional and can be applied depending on particular testing scenarios and line transmission characteristics) are used to produce the enhanced TDR plot for display. In this manner, the disclosed techniques provide the advantage of enhancing TDR signals so that the noisy spikes (not related to any transmission line impairments) are removed and the sharp edges of legitimate peaks associated with transmission line impairments are maintained.

Some implementations of the disclosed techniques are designed to operate with transmission lines having 24 AWG and 26 AWG wire diameters. Certain parameters are configurable corresponding to various transmission line characteristics so as to optimize the resulting enhanced TDR plot. In some examples, the techniques for enhancing SELT signals are applied to DSL modems, which operate at different bandwidths (e.g., 2.2 MHz, 8.5 MHz, 12 MHz, and 17.6 MHz). It is to be appreciated that, while the present disclosure describes the techniques for enhancing SELT signals in the context of DSL systems, aspects of the present disclosure are equally applicable to other communication systems. For example, aspects of the present disclosure apply to testing processes for various wired communication technologies including, but not limited to, frequency division multiplexing (FDM) and orthogonal frequency division multiplexing (OFDM) systems associated with coaxial cable communications, power line communications, Ethernet communications, and other wired communication systems where appropriate.

Additionally, related U.S. application Ser. Nos. 14/341,538 and 14/341,576, assigned to the assignee hereof, the entire contents of which are expressly incorporated by reference herein, provide examples for analyzing loops using SELT process. The techniques for enhancing SELT signals described in the present disclosure aid in accurately identifying and locating impairments using SELT processes.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

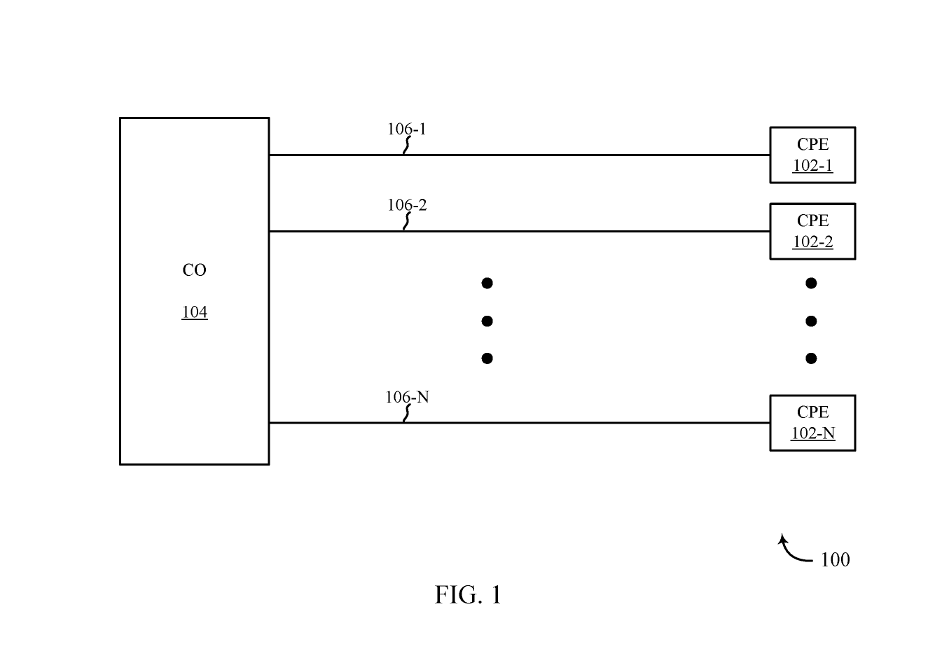

Referring first to FIG. 1, a block diagram illustrates an example of a DSL system 100 in which techniques for enhancing SELT signals can be implemented in accordance with various aspects of the present disclosure. The DSL system includes a plurality of N customer premise equipment (CPE) transceivers 102-1 to 102-N that are operatively coupled to a central office (CO) 104 via respective loops 106-1 to 106-N. In one example, DSL system 100 can be a DSL system operating according to very-high-bit-rate digital subscriber line 2 (VDSL2) technology, in which some or all of transceivers 102-1 to 102-N are configured as a vectoring group by CO 104.

In some examples, loop diagnostics for DSL system 100 are based at least in part on analysis of SELT processes and data therefrom. For example, CPE transceiver 102-1 can perform diagnostics to characterize loop 106-1 using SELT signals transmitted by CPE 102-1 on loop 106-1 and reflected back to CPE transceiver 102-1. Specifically, when DSL system 100 is operating according to VDSL2, a conventional SELT performed by CPE transceiver 102-1 can include continuously transmitting symbols (e.g., modulated REVERB symbols) during each VDSL2 symbol period for a time period of approximately five seconds to two minutes, and measuring the signal reflections (i.e., obtaining S11 data) from loop 106-1. Some or all of the other CPE transceivers 102-2 to 102-N can be operating in showtime mode using the same symbol periods while CPE transceiver 102-1 performs the SELT processes.

The CPE transceivers 102-1 to 102-N of DSL system 100 operating according to VDSL2 are assigned certain frequency bands in which the CPE transceivers 102-1 to 102-N are permitted to transmit upstream signals according to a prescribed DSL system frequency band plan. Additionally, equipment in CO 104 such as a DSL access multiplexer (DSLAM) are assigned certain frequency bands in which the equipment in the CO 104 is permitted to transmit downstream signals according to the prescribed DSL system frequency band plan.

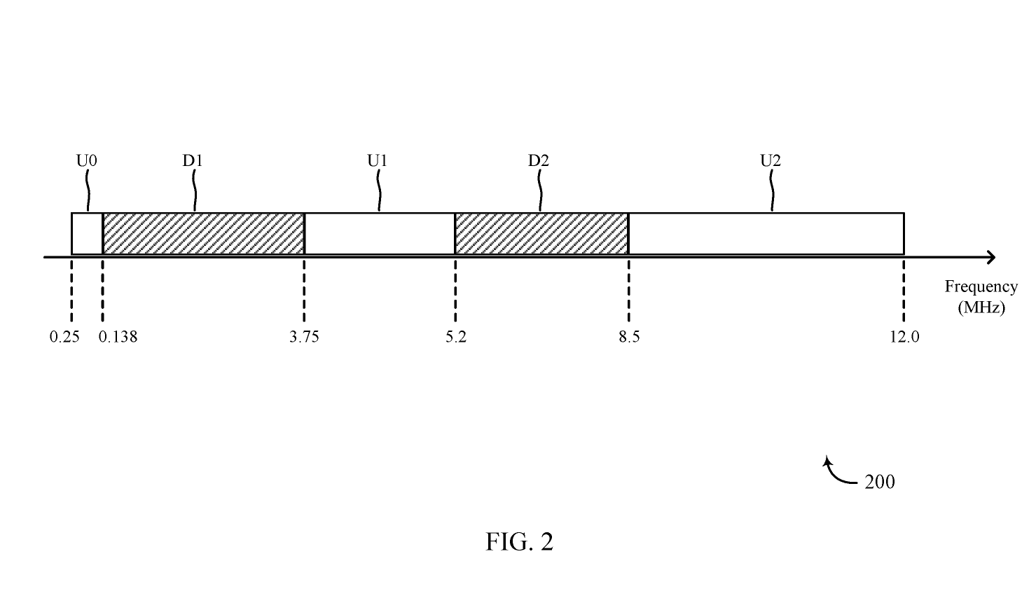

FIG. 2 illustrates an example of a DSL system frequency band plan 200 in which techniques for enhancing SELT signals can be implemented in accordance with various aspects of the present disclosure. DSL system frequency band plan 200 corresponds to the frequency band plan provided in ITU-T Standard, G.993.2, SERIES G: TRANSMISSION SYSTEMS AND MEDIA, DIGITAL SYSTEMS AND NETWORKS, Digital sections and digital line system—Access networks, Very high speed digital subscriber line transceivers 2 (VDSL2), February 2006.

DSL system frequency band plan 200 includes three upstream frequency bands U0 (comprising tones from 0.025 MHz to 0.138 MHz), U1 (comprising tones from 3.75 MHz to 5.2 MHz) and U2 (comprising tones from 8.5 MHz to 12.0 MHz) and two downstream frequency bands D1 (comprising tones from 0.138 MHz to 3.75 MHz) and D2 (comprising tones from 5.2 MHz to 8.5 MHz). Conventional SELT processes are conducted using only upstream frequency bands from the CPE transceivers and downstream frequency bands from the CO.

However, in accordance with aspects of the present disclosure, enhanced SELT processes are conducted using both upstream and downstream frequency bands from CPE transceivers 102-1 to 102-N and both upstream and downstream frequency bands from equipment in the CO 104. In some cases, enhanced SELT processes are conducted over the entire DSL system frequency band plan 200. In this manner, frequency domain S11 data across a wide frequency band is used in providing enhanced TDR signals in accordance with aspects of the present disclosure.

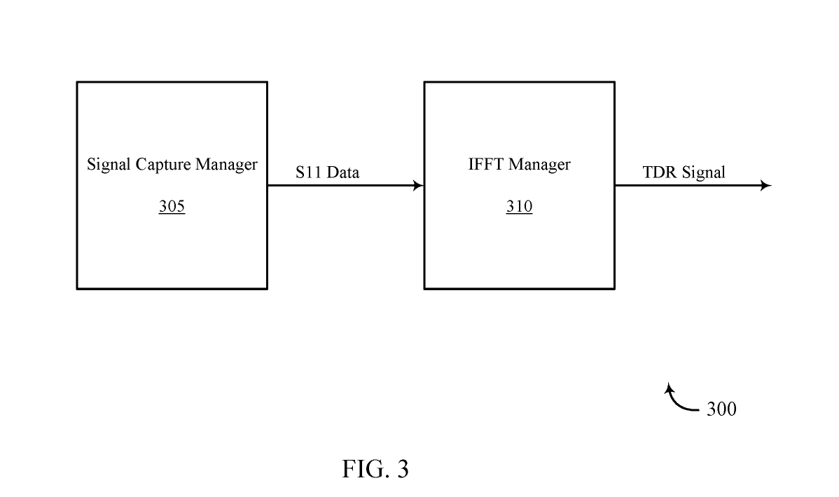

FIG. 3 shows a block diagram of an example of a test device 300 that supports enhancing SELT signals in accordance with various aspects of the present disclosure. The test device can include a signal capture manager 305 and an IFFT manager 310. The Aspects of the test device 300 can implemented in a remote testing system (e.g., integrated with a DSL modem or with a DSLAM) or a technician's handheld test unit.

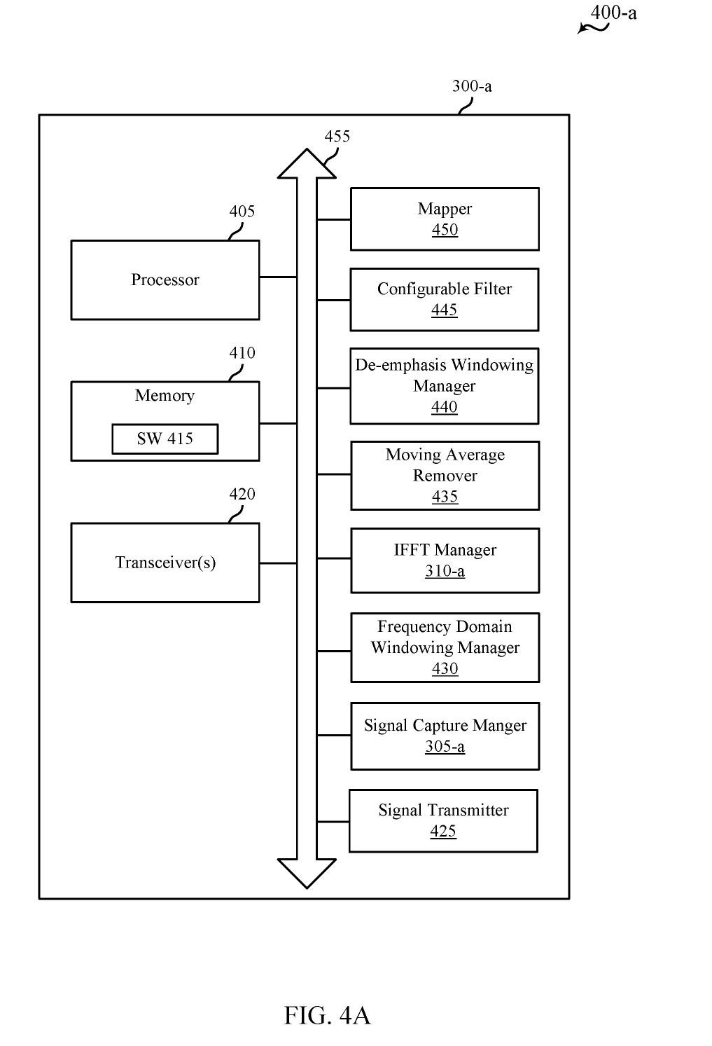

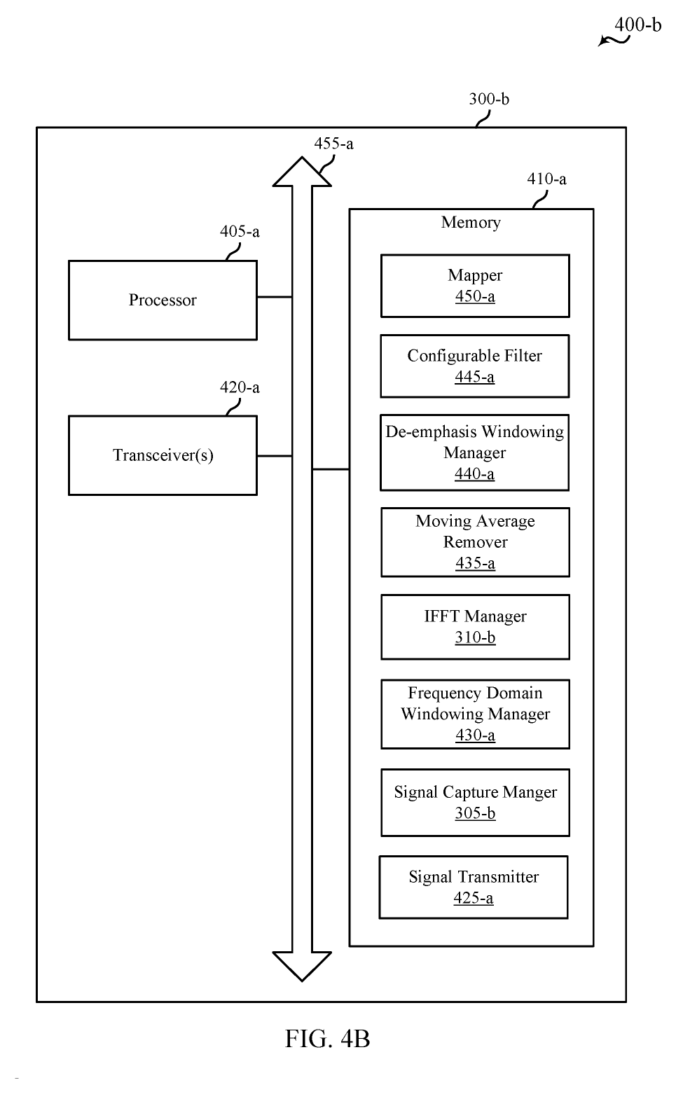

The signal capture manager 305 includes an SELT capture function for receiving the reflected signals in response to a transmitted test signal. The signal capture manager 305 also converts the reflected signals into frequency domain data. For example, in SELT processes, reflection coefficient(s) in the frequency domain are referred to as frequency domain S11 data. This frequency domain S11 data is provided to the IFFT manager 310, which determines and generates a TDR signal based at least in part on this frequency domain data. The TDR signal (as well as the frequency domain S11 data in some cases) is provided to an analysis engine of the test device 300. The analysis engine, which can include the IFFT manager as well as other modules described herein with respect to FIGS. 4A and 4B, processes the TDR signal and frequency domain S11 data to detect to presence of transmission line impairments.

In some examples, the test device 300 adheres to one or more of the following enhanced TDR signal processing principles. The enhanced TDR signal is used as a reinforcement of the analysis engine results. In this manner, the enhanced TDR signal provides a measure of protection against certain analysis engine limitations and failures. Thus, in some implementations, the enhanced TDR signal and resulting TDR plot is independent of certain analysis engine determinations. The enhanced TDR signal should replicate similar or conventional TDR plots, but with higher resolution. All significant peaks due to real transmission line impairments should preserved when determining the enhanced TDR signal. The polarity of the transmission line impairments (e.g., even in case of multiple transmission line impairments in a single plot) should be preserved when generating the enhanced TDR signal and resulting TDR plot. Spurious spikes and/or peaks (e.g., noise, signal anomalies, and/or signal artifacts) should be smoothed out to generate an enhanced TDR signal and resulting clean TDR plot. In this manner, the resulting TDR plot for display should not include any sharp peaks that will confuse the technical support personnel. Transmission line impairments close or proximal to the CPE (or other far-end line termination) as well as transmission line impairments further away from the CPE (or other far-end line termination) should be preserved in the resulting TDR plot.

It is to be further noted that the various filtering and windowing processes disclosed herein are tuned for each particular frequency band of the test signal, and these various filtering and windowing processes can be tuned for specific bandwidths used in the various implementations of the test device 300.

FIG. 4A shows a block diagram 400-a of an example of a test device 300-a that support enhancing SELT signals in accordance with various aspects of the present disclosure, and with respect to FIGS. 1 through 3. The test device 300-a includes a processor 405, a memory 410, one or more transceivers 420, a signal transmitter 425, a signal capture manager 305-a, a frequency domain windowing manager 430, an IFFT manager 310-a, a moving average remover 435, a de-emphasis windowing manager 440, a configurable filter 445, and a mapper 450. The processor 405, memory 410, transceiver(s) 420, signal transmitter 425, signal capture manager 305-a, frequency domain windowing manager 430, IFFT manager 310-a, moving average remover 435, de-emphasis windowing manager 440, configurable filter 445, and mapper 450 are communicatively coupled with a bus 455, which enables communication between these components. In some examples (e.g., remote testing systems), one or more links of the test device 300-a are communicatively coupled with the transceiver(s) 420.

The processor 405 is an intelligent hardware device, such as a central processing unit (CPU), a microcontroller, an application-specific integrated circuit (ASIC), etc. The memory 410 stores computer-readable, computer-executable software (SW) code 415 containing instructions that, when executed, cause the processor 405 or another one of the components of the test device 300-a to perform various functions described herein, for example, to filter and enhance the TDR signals with various pre-processing steps such that the TDR signals will show impairments clearly and spurious peaks (e.g., noise, signal anomalies, and/or signal artifacts) associates with the TDR signals are reduced.

The signal transmitter 425, signal capture manager 305-a, frequency domain windowing manager 430, IFFT manager 310-a, moving average remover 435, de-emphasis windowing manager 440, configurable filter 445, and mapper 450 implement the features described with reference to FIGS. 1 through 3, as further explained below.

Again, FIG. 4A shows only one possible implementation of a test device executing the features of FIGS. 1 through 3. While the components of FIG. 4A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 4A may be implemented by a single, consolidated hardware block. For example, a single transceiver 420 chip or the like may implement the processor 405, signal transmitter 425, signal capture manager 305-a, frequency domain windowing manager 430, IFFT manager 310-a, moving average remover 435, de-emphasis windowing manager 440, configurable filter 445, and mapper 450.

In still other examples, the features of each component may be implemented, in whole or in part, with instructions embodied in a memory, formatted to be executed by one or more general or application-specific processors. For example, FIG. 4B shows a block diagram 400-b of another example of a testing device 300-b in which the features of the signal transmitter 425-a, signal capture manager 305-b, frequency domain windowing manager 430-a, IFFT manager 310-b, moving average remover 435-a, de-emphasis windowing manager 440-a, configurable filter 445-a, and mapper 450-a are implemented as computer-readable code stored on memory 410-a and executed by one or more processors 405-a. Other combinations of hardware/software may be used to perform the features of one or more of the components of FIGS. 4A and 4B.

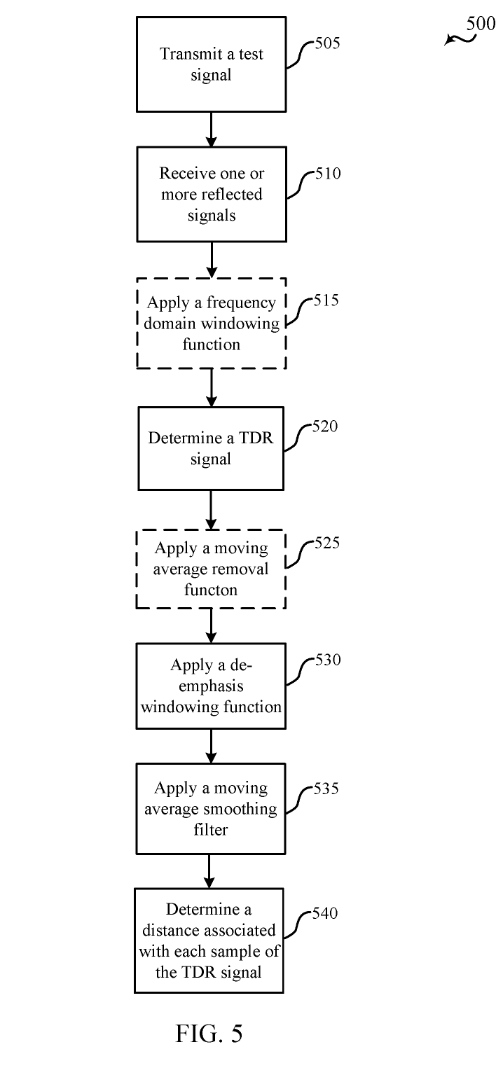

FIG. 5 shows a flow chart that illustrates on example of a method 500 for enhancing SELT signals in accordance with various aspects of the present disclosure. Method 500 may be performed by any of the test devices discussed in the present disclosure, but for clarity method 500 will be described from the perspective of test device 300-a of FIG. 4A. It is to be understood that method 500 is just one example of techniques for enhancing SELT signals, and the operations of method 500 may be rearranged, performed by other devices and component thereof, and/or otherwise modified such that other implementations are possible.

Broadly speaking, method 500 illustrates a procedure by which test device 300-a enhances SELT signals. The method 500 receives reflected signals in response to a transmitted test signal and determines a TDR signal based at least in part on frequency response data (e.g., frequency domain S11 data) associated with the received reflected signals. The method 500 the applies a de-emphasis windowing function to the TDR signal.

At block 505, the signal transmitter 425 of the test device 300-a transmit a test signal on the DSL transmission line. In some cases, the signal transmitter 425 transmits the test signal in at least one upstream frequency band (e.g., U0, U1, and/or U2) and at least one downstream frequency band (e.g., D1 and/or D2) in a DSL system frequency band plan.

At block 510, the signal capture manager 305-a of the test device 300-a receives one or more reflected signals in response to the transmitted test signal. The signal capture manager 305-a also converts the one or more reflected signals into frequency domain data.

In one option, at block 515, the frequency domain windowing manager 430 of the test device 300-a applies a frequency domain windowing function to the frequency response data. This optional frequency domain windowing function is performed prior to the test device 300-a determining the TDR signal. For example, the frequency domain S11 is passed through a frequency domain window such as, but not limited to a tukey-based customized window. In this manner, the frequency domain windowing function aids in enhancing the legitimate impairment signatures. However, this optional frequency domain windowing function may be turned off based on user preference or specific implementations. In some cases, this frequency domain windowing function tends to increase the negative dip before a positive peak to aid in identifying an impairment (e.g., a bridge tap that typically includes a positive and negative peak impairment signature).

At block 520, the IFFT manager 310-a of the test device 300-a performs an IFFT function on the frequency domain data to determine and generate a TDR signal. In some examples, a 32K IFFT is used in this IFFT function to obtain the best details for DSL transmission lines. In this regard, the IFFT bit precision may be maintained at minimum of 32 bits to capture all signal peaks. The accumulation for this 32-bit IFFT bit precision scenario is 64 bits.

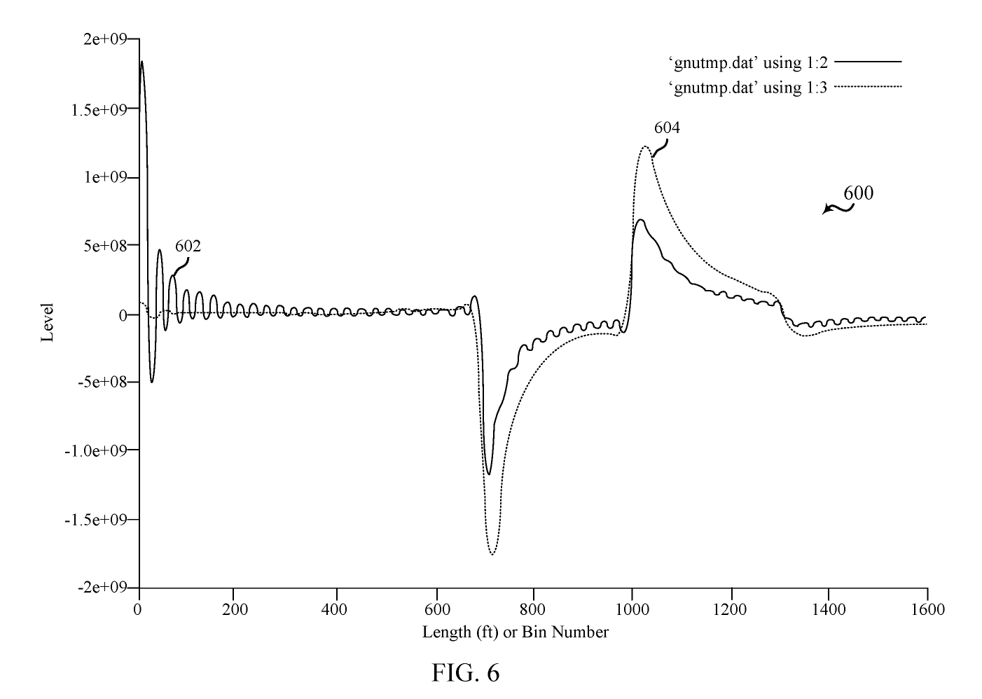

According to one option, at block 525, the moving average remover 435 of the test device 300-a applies a moving average removal function to the TDR signal. This moving average removal function removes any large non-zero mean signals. As can be seen in FIGS. 6, 7, and 8, a large signal energy is present close or proximal to the CPE or other far-end line termination (e.g., 0 ft. on the distance axis of the TDR plots). However, to avoid losing legitimate impairment signal peaks, the averaging window should be chosen appropriately (e.g., chosen based at least in part on particular transmission line characteristics or previously successful averaging windows for similar testing environments). Of particular concern is that this moving average removal function can cause muting of the BT peaks and line-cut peaks. This moving average removal function may be turned off based on user preference or specific implementations.

At block 530, the de-emphasis windowing manager 440 of the test device 300-a applies a de-emphasis windowing function to the TDR signal. The de-emphasis windowing function is used to mute out aspects of the TDR signal close or proximal to the CPE or other far-end line termination. In some examples, the emphasis windowing function includes a multi-slope linear window. It is to be appreciated, however, that other high-order windows can also be used. Moreover, in some implementations, the de-emphasis windowing function is only applied proximal to the CPE or other far-end line termination, and at distances away from the CPE or other far-end line termination, no de-emphasis windowing function is applied.

In some examples, the de-emphasis windowing manager 440 applies a de-emphasis attenuation factor of the de-emphasis windowing function based at least in part on a characteristic of the DSL transmission line. For example, a de-emphasis attenuation factor for a DSL transmission line having 24 AWG wire diameter is different from a de-emphasis attenuation factor for a DSL transmission line having 26 AWG wire diameter.

In one non-limiting example, a linear algorithm for the de-emphasis windowing function is as follows:

W(1)=1;

For i=2:s

W(i)=W(i−1)+x*d

For i=s+1:end

W(i)=W(i−1)+d,

where the values of d, s, x are optional parameters.

It is to be appreciated that the example algorithm can also be made a higher-order rather than linear window. The values in this non-limiting example for a 24 AWG wire diameter scenario are d=16/4096; s=20; and x=9.

At block 535, the configurable filter 445 of the test device 300-a applies a moving average smoothing filter. In some examples, this moving average smoothing filter is applied to the TDR signal. However, in other examples, the moving average smoothing filter is applied directly to the one or more reflected signals or to another frequency domain reflectometry (FDR) signal in the process of determining and generating the TDR signal.

Additionally, in some examples, the configurable filter 445 varies a number of samples associated with a window size of the moving average smoothing filer. For example, the window size can be varied from 32 samples to 256 samples. In this regard, a larger window size used in the moving average smoothing filter generally results in a cleaner TDR signal and TDR plot. However, it is to be noted that excessively long window sizes can also mute out legitimate impairment signal peaks. Thus, in some implementations, window sizes having 128 samples or 256 samples are used in the moving average smoothing filter.

At block 540, a mapper 450 of the test device 300-a determines a distance associated with each of one or more samples of the TDR signal. This distance determination is performed with respect to the TDR signal after the de-emphasis windowing manager 440 applies the de-emphasis windowing function and after any other windowing and filtering functions as described herein are performed by the test device 300-a. For example, the one or more samples of the TDR signal are mapped to distance in ft. In this manner, the resulting enhanced TDR the plot will identify peaks at specific distances, thereby making it easier for technical support personnel to understand the DSL transmission line and loop makeup.

It is to be appreciated that, in some cases, there may be several impairments and loop scenarios that will not be detected by a conventional testing device. In such cases, it is useful to augment the testing device with an enhanced TDR signal and resulting TDR plot as described herein. As shown in FIGS. 6 through 8, the techniques described herein filter and enhance the resulting TDR plot with various pre-processing steps such that the resulting TDR plot will show transmission line impairments clearly and spurious spikes and/or peaks (e.g., noise, signal anomalies, and/or signal artifacts) are reduced. In this manner, the enhanced TDR plot can enable technical support personnel to make a more accurate judgment of the loop makeup to detect and determine line impairments or other problems on the transmission line

FIG. 6 illustrates examples of TDR plots 600 for a 300 ft. bridge tap at 700 ft. in accordance with various aspects of the present disclosure. As shown in FIG. 6, an original TDR plot line 602 is cleaned using the techniques described herein to generate an enhanced TDR plot line 604 such that a 300 ft. bridge tap can be clearly identified at 700 ft.

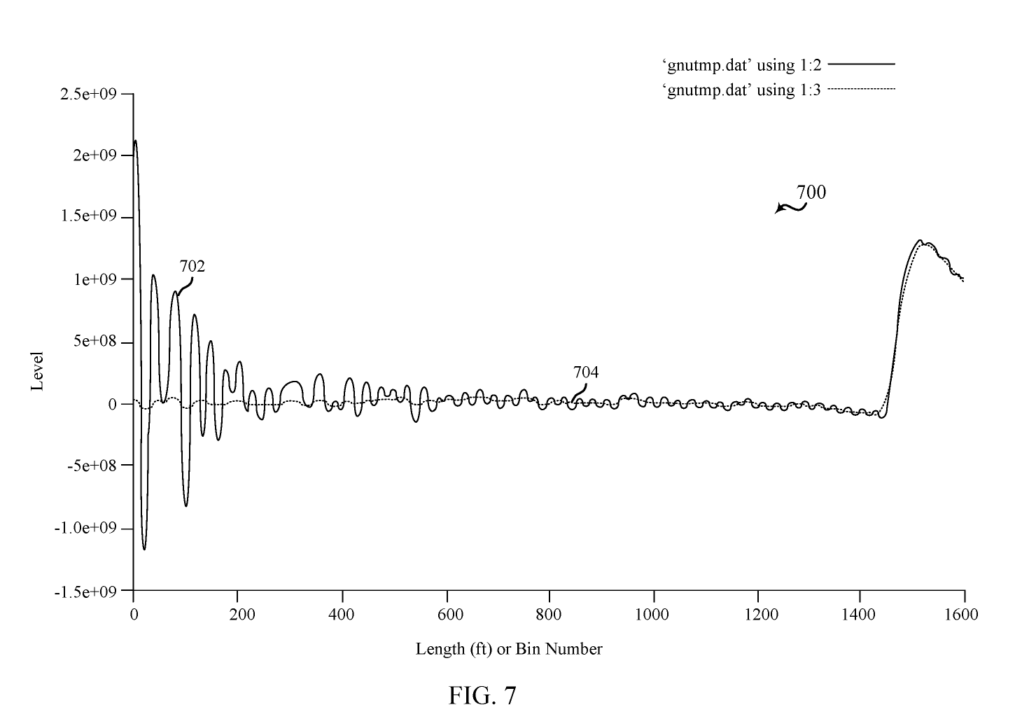

FIG. 7 illustrates examples of TDR plots 700 for a line cut at 1,500 ft. in accordance with various aspects of the present disclosure. As shown in FIG. 7, an original TDR plot line 702 is cleaned using the techniques described herein to generate an enhanced TDR plot line 704 such that a line cut at 1,500 ft. can be clearly identified.

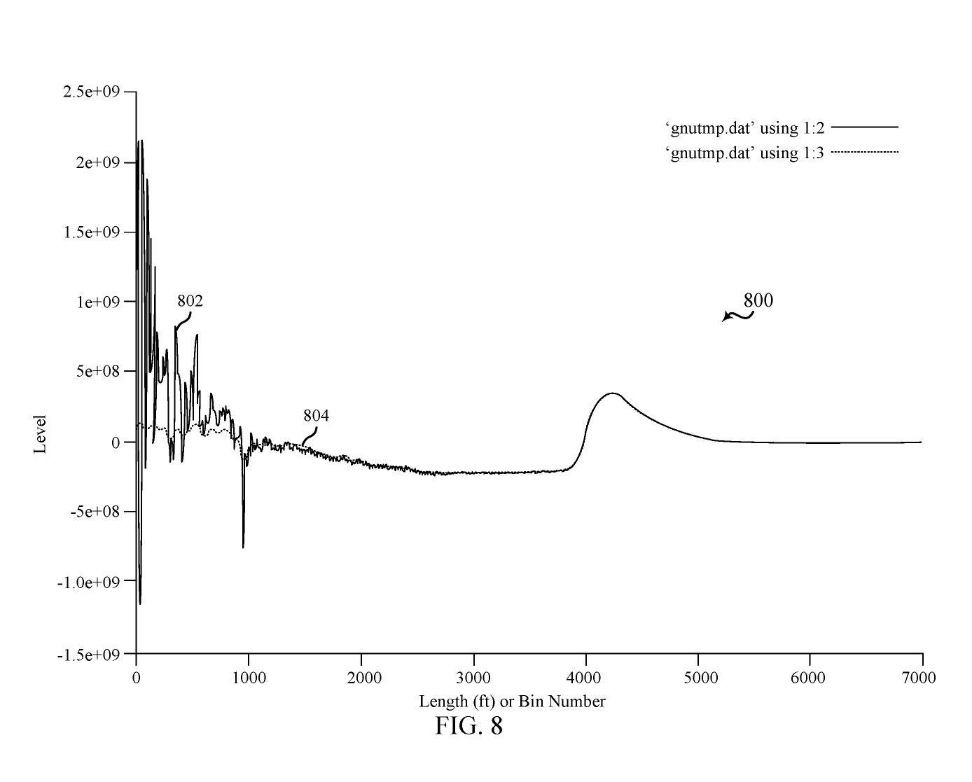

FIG. 8 illustrates examples of TDR plots 800 for a line cut at 4,000 ft. in accordance with various aspects of the present disclosure. As shown in FIG. 8, an original TDR plot line 802 is cleaned using the techniques described herein to generate an enhanced TDR plot line 804 such that a line cut at 4,000 ft. can be clearly identified.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these.

Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein

What is claimed is:

1. A method for measuring impairments in a transmission line, the method comprising:
receiving one or more reflected signals in response to a transmitted test signal;
determining a time domain reflectometry (TDR) signal based at least in part on frequency response data associated with the received one or more reflected signals; and
applying a de-emphasis windowing function to the TDR signal.

2. The method of claim 1, further comprising:
applying a frequency domain windowing function to the frequency response data prior to determining the TDR signal.

3. The method of claim 1, wherein determining the TDR signal comprises performing an inverse fast Fourier transform (IFFT) function on the frequency response data.

4. The method of claim 1, further comprising:
applying a moving average removal function to the TDR signal.

5. The method of claim 1, wherein applying the de-emphasis windowing function comprises applying a multi-slope linear window.

6. The method of claim 1, further comprising:
applying a moving average smoothing filter to a signal, wherein the signal is a member of the group consisting of: the received one or more reflected signals, the TDR signal, and a frequency domain reflectometry (FDR) signal.

7. The method of claim 6, wherein applying the moving average smoothing filter to the signal comprises varying a number of samples associated with a window size of the moving average smoothing filter.

8. The method of claim 1, further comprising:
determining a distance associated with each of one or more samples of the TDR signal after applying the de-emphasis windowing function.

9. The method of claim 1, wherein the frequency response data comprises frequency domain S11 data from at least one upstream frequency band and at least one downstream frequency band in a digital subscriber line (DSL) system frequency band plan.

10. The method of claim 1, wherein a de-emphasis attenuation factor of the de-emphasis windowing function is based at least in part on a characteristic of the transmission line.

11. A device for measuring impairments on a digital subscriber line (DSL) transmission line, the device comprising:
a signal transmitter to transmit a test signal on the DSL transmission line;
a signal capture manager to receive one or more reflected signals in response to the transmitted test signal and to convert the one or more reflected signals into frequency domain data;
an inverse fast Fourier transform (IFFT) manager to perform an IFFT function on the frequency domain data to generate a time domain reflectometry (TDR) signal; and
a de-emphasis windowing manager to apply a de-emphasis windowing function to the TDR signal.

12. The device of claim 11, further comprising:
a frequency domain windowing manager to apply a frequency domain windowing function to the frequency response data prior to determining the TDR signal.

13. The device of claim 11, further comprising:
a moving average remover to apply a moving average removal function to the TDR signal.

14. The device of claim 11, wherein the de-emphasis windowing manager is further to apply a multi-slope linear window.

15. The device of claim 11, further comprising:
a configurable filter to apply a moving average smoothing filter to a signal, wherein the signal is a member of the group consisting of: the received one or more reflected signals, the TDR signal, and a frequency domain reflectometry (FDR) signal.

16. The device of claim 15, wherein the configurable filter is further to vary a number of samples associated with a window size of the moving average smoothing filer.

17. The device of claim 11, further comprising:
a mapper to determine a distance associated with each of one or more samples of the TDR signal after applying the de-emphasis windowing function.

18. The device of claim 11, wherein the signal transmitter is further to transmit the test signal in at least one upstream frequency band and at least one downstream frequency band in a DSL system frequency band plan, and wherein the IFFT manager is further to perform the IFFT function on the frequency domain data comprising frequency domain S11 data from the at least one upstream frequency band and the at least one downstream frequency band.

19. The device of claim 11, wherein the de-emphasis windowing manager is further to apply a de-emphasis attenuation factor of the de-emphasis windowing function based at least in part on a characteristic of the DSL transmission line.

20. A non-transitory computer-readable medium comprising computer-readable code that, when executed, causes a device to:
transmit a test signal on a digital subscriber line (DSL), the test signal being transmitted in at least one upstream frequency band and at least one downstream frequency band in a DSL system frequency band plan;
receive one or more reflected signals in response to the transmitted test signal and convert the one or more reflected signals into frequency domain data;
perform an inverse fast Fourier transform (IFFT) function on the frequency domain data to generate a time domain reflectometry (TDR) signal;
apply a de-emphasis windowing function having a multi-slope linear window to the TDR signal;
apply a moving average smoothing filter to the TDR signal; and
determine a distance associated with each of one or more samples of the TDR signal after applying the de-emphasis windowing function and the moving average smoothing filter.
